(19) United States
(12) Patent Application Publication
(10) Pub. No.: US 2005/0033910 A1
(43) Pub. Date: Feb. 10, 2005

(54) Method for data transfer

(76) Inventor: Michael Sommer, Raubling (DE)

Correspondence Address: SLATER & MATSIL, L.L.P., 17950 PRESTON RD, SUITE 1000, DALLAS, TX, 75252-5793, US

(21) Appl. No.: 10/881,722

(22) Filed: Jun. 30, 2004

(30) Foreign Application Priority Data
Jun. 30, 2003 (DE) 103 29 395.7

(51) Int. Cl. G06F 12/00

(52) U.S. Cl. 711/105

(57) ABSTRACT

The document describes a method for transferring data between a memory device and a read/write device. In this case, a system clock is produced at a system clock rate and a data transfer clock is produced at a data transfer clock rate. In addition, control commands for controlling the data transfer are transferred in sync with the system clock, and data are transferred in line with corresponding control commands in sync with the data transfer clock. The system clock rate and the data transfer clock rate can be set as desired in this context. In particular, the data transfer clock rate is chosen to be higher than the system clock rate, which means that a higher data transfer rate than previously is possible.

This application claims priority to German Patent Application 103 29 395.7, which was filed Jun. 30, 2003 and is incorporated herein by reference.

### TECHNICAL FIELD

The invention relates to a method for transferring data between a memory device and a read/write device.

### BACKGROUND

When a memory chip is used, the speed at which data can be transferred between the memory chip and an external read/write device is one of the most important parameters. A high read/write speed is of the greatest importance for a large number of applications.

To date, essentially memory-specific protocols have been developed that allow data access operations and read/write commands to be performed with optimized timing. The starting point for the development of the memory chips available today may be regarded as being the EDO (Extended Data Output) chip. The EDO chip is characterized, in particular, by its relatively complicated timing specification. The EDO chip was taken as the basis for developing the SDRAM (Synchronous Dynamic Random Access Memory) chip. The introduction of the SDRAM allowed the basic design of the EDO chip to be retained. The fundamental innovation of the SDRAM or the SDRAM chip can be seen in the introduction of a system clock. This allowed the actuation logic to be simplified and, concurrently, allowed the performance of the chip to be optimized. The clocked logic essentially allows commands to be initiated actually during a data transfer, so as to order a data transfer at a firmly prescribed time. This allowed a never-ending, i.e., continuous, data stream. The commands that control access to the memory chip are followed, after a time delay, e.g., as a result of the CAS (Column Address Strobe) latency, by the data transfer during a read access operation. In this case, a good timing design for the commands essentially represents the gain in performance for SDRAM chips over EDO chips.

To increase the data rate further, the DDR (Double Data Rate) principle was also introduced, which virtually doubles the data rate. In comparison with the SDRAM chip, the command design has been retained for the DDR principle or DDR memory chip or DDR chip. The access time has not been improved for the DDR chip, as compared with the SDRAM chip, and the clock rate for the commands has therefore not been increased. The fundamental innovation of the DDR principle or DDR chip is the conversion/processing of two successive or serial data items to produce a data record or parallel data record during the write operation, and vice versa during the read operation. In the case of the DDR chip, the data are read from the chip and written not just upon the rising clock edge, as in the case of the commands, but also upon the falling clock edge. At high frequencies, the DDR principle requires a DLL (Delay Locked Loop) circuit. This allows sure centering of the data in relation to the rising and falling clock edges. The increased parallelism inside the chip or memory chip can thus be used, together with a fast I/O interface design, to double the data rate as seen from the outside with almost the same access time.

The memory chips' access times, which remain more or less static, mean that increasing the clock rate or system frequency or system clock rate is of only limited benefit. Even in the case of a maximum parallel reading concept, the command frequency is also limited by the access time for the memory cell. Increasing the clock rate results in further problems, particularly in increased CAS latencies. However, the number of CAS latencies cannot be increased as desired without the data stream inevitably being interrupted by breaks upward of a certain frequency.

### SUMMARY OF THE INVENTION

In one aspect, the invention provides a method for transferring data between a memory device and a read/write device, which allows for a higher data transfer rate than previously.

The preferred embodiment inventive method for transferring data between a memory device and a read/write device involves the following steps being performed: a system clock is produced at a system clock rate, a data transfer clock is produced at a data transfer clock rate, control commands for controlling the data transfer are transferred in sync with the system clock, and data are transferred in line with corresponding control commands in sync with the data transfer clock. In this case, the system clock rate and the data transfer clock rate can be set as desired.

One aspect of the invention is thus setting the system clock rate and the data transfer clock rate differently. The maximum possible system clock rate is dependent on the memory chip's access time, in particular, and therefore cannot be increased as desired. On the other hand, the data transfer clock rate can be chosen to be higher and is dependent on the memory device's access speed, in particular. In other words, the invention allows the data transfer clock rate at which data are transferred and the system clock rate, at which control commands are transferred, to be respectively optimized independently of one another, and thus allows the data transfer rate to be increased.

Preferably, the control commands used are read commands and/or write commands and/or other commands for data transfer. Examples of other commands are: de-select, No Operation, Active (select bank and activate row), Read/write (select bank and column and start to read/write burst), burst terminate, pre-charge (de activate row in bank or banks), auto-refresh, self-refresh (enter self-refresh mode), mode register set (determination of the mode of the chip).

In addition, the data transfer clock rate is preferably chosen to be higher than the system clock rate. In this regard, it should be noted that the data rate's limiting currently does not involve the driver strength of the “off-chip driver (OCD)” or the latter's switching behavior. Similarly, the receivers or the read/write device currently do not represent any limitation on the data rate. For the receivers, the demand for the maximum data rate, i.e., the maximum data transfer rate, can normally be equated to the demand for the maximum permissible power consumption. A CMOS process today, which is typical of DRAM technology, has a non-limiting effect in relation to device performance. By contrast, the connection planes on which the CMOS process is based have a fundamental delay (access time) in connection with the memory cells' reading circuit. The access time has been improved only to an insignificant extent over a plurality of chip generations. The preferred embodiment of the invention now allows the system clock rate to be matched to the access time and allows the data transfer clock rate to be matched to the memory device's access speed at which data can be read and written. Preferably, the data transfer clock rate corresponds to a multiple of the system clock rate.

In addition, the data transfer clock rate is preferably optimized on the basis of parameters, which stipulate the maximum data transfer rate, which can be achieved between the memory device and/or the read/write device.

As already mentioned above, such a parameter is the maximum permissible power consumption. A further parameter is obtained as a result of the metallization layers, with three metallization layers M0, M1, and M2 being used, for example. If a prefetch of 2 is performed, for example, that is to say 32 I/O data items, that is to say bits, are fetched or read, with just 16 I/O data items having been requested during a read command, then 32 data lines are needed, which results in a higher level of complexity for the design of the chip. In this case, it is sometimes also necessary to increase the area of the chip, for example, which may result in longer propagation delays. A further parameter, which influences the maximum data transfer rate that can be achieved, is the transistor properties of the transistors used. In this case, the speed of the transistors, in particular, has an effect, that is to say whether slow or fast transistors are used. A further parameter which influences the maximum data transfer rate which can be achieved is obtained as a result of the length of the data paths used. If three instead of five gates are present in a data path, for example, then a higher maximum data transfer rate is obtained.

In particular, the data transfer clock rate is preferably optimized on the basis of the degree of parallelization and/or the access speed of the memory device and/or of the read/write device. In this case, the degree of parallelization means how many data lines are used in parallel. If 32 data lines are used, for example, then 32 I/O data items can be read or written in parallel.

The system clock rate is preferably optimized on the basis of the access time of the memory device and/or of the read/write device. In addition, the system clock rate can be optimized on the basis of other parameters, which stipulate the maximum command transfer rate. As already mentioned, such parameters are obtained, by way of example, from the connection planes on which the CMOS process is based in connection with the memory cells' reading circuit. The maximum possible command transfer rate may also be stipulated on the basis of the motherboard, the wiring and/or the north bridge (e.g., memory controller). The command transfer rate may also be dependent on how often a processor requests data because they are not present in the cache.

In one preferred embodiment, the data transfer clock is produced from the system clock using a mode register set. In this case, the data transfer clock rate is obtained by multiplying the fundamental frequency, i.e., the system clock rate.

For this purpose, it is also possible to use an extended mode register set. Both when a mode register set is used and when an extended mode register set is used, the default value, i.e., standard value, used for the data transfer clock rate may be that for a DDR chip, which results in additional compatibility. The mode register set stipulates the mode of the chip when the computer has been turned on, for example the CAS latency and the burst length are stipulated; the extended mode register set is used to operate the chip, by way of example, in weak mode with soft edges, which results in fewer reflections. The preferred embodiment of the invention now involves the command set, that is to say the possible commands in the mode register set and/or in the extended mode register set, being extended. One possible command stipulates the multiplication factor for the system clock rate, for example. That is to say that the multiple of the system clock frequency, which is used for transferring data, is stipulated. In this case, the chip is operated in double data rate mode as a standard value. However, an appropriate command may also be used to operate the chip in triple or quadruple mode, for example, or in an n-fold mode.

It is also possible for the data transfer clock to be generated using a radio clock. In this case, the radio clock may be incorporated in both systems, i.e., the memory and the surroundings or the read/write device. The advantage obtained in this context is that the system clock no longer needs to be transferred by means of a bus connection.

Another advantage of the inventive method is when the data are transferred centered in relation to rising and/or falling clock edges of the data transfer clock using a delay locked loop circuit. The task of the delay locked loop circuit (DLL) is to clock out data cleanly, that is to say to synchronize them, with the edges when driving, that is to say when reading data from, the memory chip. If the frequency of the data transfer clock rate changes, then the delay locked loop circuit can also be used to synchronize data cleanly, i.e., accurately, with the edges of the data transfer clock.

Aspects of the invention allow the data transfer rate to be achieved using a novel extension of the tasks of the DLL (Delay Locked Loop) circuit and further parallelization of the data processing. In the case of the preferred embodiment, the data rate is not reached by increasing the frequency of the system clock—the system clock remains at a relatively low clock rate. The delay locked loop circuit (DLL) is intended to continue to center itself in relation to falling and rising clock edges, as has also been the case with a DDR chip hitherto. What is new is that the data are no longer clocked out with triggering at precisely these clock edge times, but rather the data are sent and adopted at virtual clock edges. The accuracy of a delay locked loop circuit (DLL) makes it possible for system frequencies to be exactly halved, divided by three or divided by any integer number. The period duration of the system frequency, i.e. the system clock rate, can thus be optimized using the access time in the memory chip. Depending on the degree of parallelization and the access speed, the data transfer clock rate or data transfer frequency is increased to any desired multiple of the fundamental frequency. This optional multiplication of the fundamental frequency may be initialized, by way of example, using a mode register set or an extended mode register set. The default value or standard value, which is set may be, by way of example, that of the DDR chip, which is tantamount to additional compatibility. It is also possible to incorporate a radio clock into both systems, i.e., the memory and the surroundings. In that case, the system clock no longer needs to be transferred by means of a bus connection.

One aspect of the invention is thus the introduction of virtual clock edges in the data transfer. Both the transmitter and the receiver produce a high-frequency on-chip system clock from a low frequency bus system clock in parallel, with physical separation and simultaneously in each case. The data are written and read in relation to the high frequency on-chip clock. Synchronization is performed using a relatively slow system block (system clock rate), which does not need to be optimized for data transfer.

### BRIEF DESCRIPTION OF THE DRAWINGS

Further features and advantages of the invention will become clear from the description below of a preferred embodiment with reference to the drawing, in which:

FIG. 1 shows a diagram to illustrate the transfer of control commands and data in line with the prior art; and

FIG. 2 shows a diagram to illustrate the transfer of control commands and data in line with a preferred embodiment of the invention.

### DETAILED DESCRIPTION OF ILLUSTRATIVE EMBODIMENTS

The making and using of the presently preferred embodiments are discussed in detail below. It should be appreciated, however, that the present invention provides many applicable inventive concepts that can be embodied in a wide variety of specific contexts. The specific embodiments discussed are merely illustrative of specific ways to make and use the invention, and do not limit the scope of the invention.

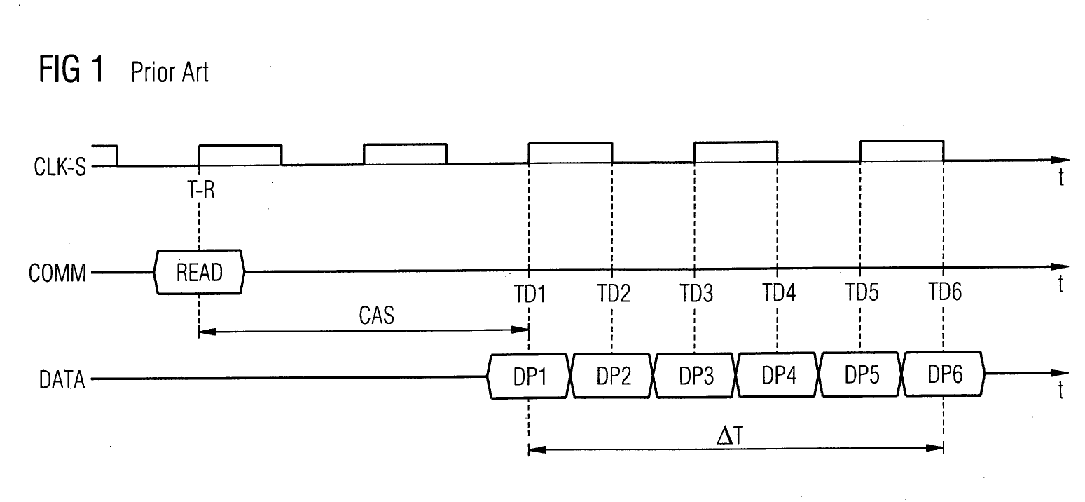

FIG. 1 shows a diagram to illustrate the transfer of control commands and data in line with the prior art. The top time axis in FIG. 1 shows the profile of a system clock CLK-S. The central time axis shows the profile of a control command signal COMM, which in the embodiment in FIG. 1, is sent from a read/write device to a memory device. The bottom time line in FIG. 1 shows the profile of a data signal DATA.

In FIG. 1, which, as already mentioned, illustrates the prior art, a read command READ is sent from the read/write device to the memory device at the time T-R. The read command READ is then processed, which requires a particular time. The delay results in the CAS latency CAS (Column Address Strobe), i.e., the read operation for data takes place after a certain delay. In the example in FIG. 1, the CAS latency is 2, i.e., data are read only after the second rising signal edge of the system clock CLK-S. The first data packet DP1 is read from the memory or from the memory device at the time TD1. Further data packets DP2, . . . , DP6 are read at subsequent times TD2, . . . , TD6, with a respective data packet being read upon rising and falling edges of the system clock CLK-S. In this case, the data packets are read centered in relation to rising and falling clock edges using a delay locked loop circuit.

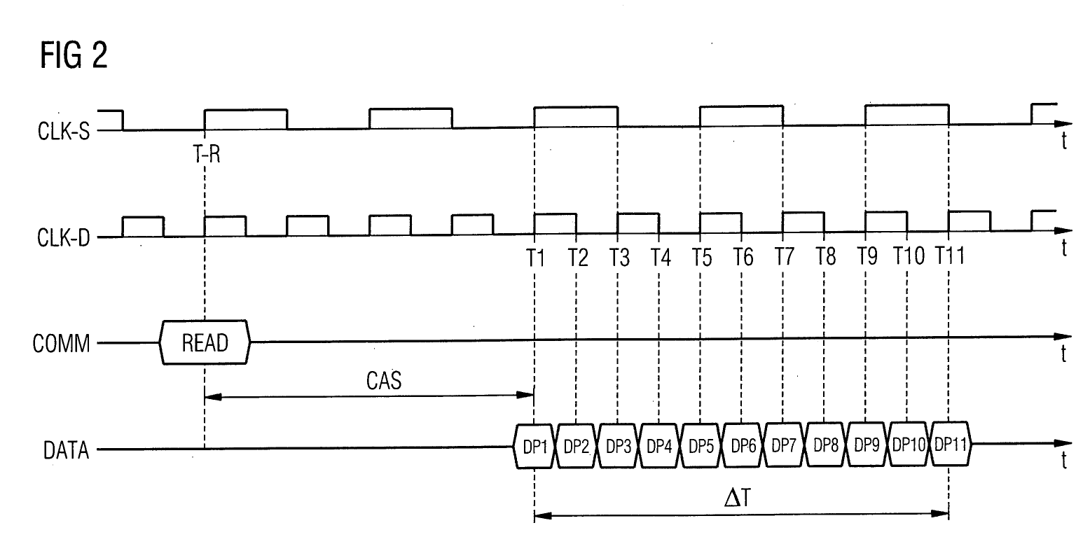

FIG. 2 shows a diagram to illustrate the transfer of control commands and data in line with a preferred embodiment of the invention. The top time line in FIG. 2 again shows the system clock CLK-S, the system clock rate having been chosen to be the same as for the prior art in FIG. 1 in order to illustrate the invention. The second time line from the top in FIG. 2 shows a data transfer clock CLK-D. In the example in FIG. 2, the clock rate of the data transfer clock CLK-D or the data transfer clock rate is twice as high as the system clock rate of the system clock CLK-S. The third time line from the top in FIG. 2 shows the profile of the control command signal COMM, and the fourth time line from the top shows the profile of the data signal DATA.

In FIG. 2, at the same time T-R as in FIG. 1, the read command READ is sent in sync with a rising edge of the system clock CLK-S. The read command READ is processed and, as a result of this, a delay is produced by the CAS latency, as before. At the time T1, the first data packet DP1 is transferred from the memory device to the read/write device. The time T1 in FIG. 2 corresponds to the time TD1 in FIG. 1, i.e., the data packet DP1 is sent at the same time in FIG. 2 and in FIG. 1. As can be seen from the data signal DATA in FIG. 2, the subsequent data packets DP2, . . . , DP11 are transferred centered upon rising and falling signal edges of the data transfer clock CLK-D at the subsequent times T2, . . . , T11. The effect achieved by a delay locked loop circuit DLL is that the data packets DP1, . . . , DP11 are respectively transferred centered in relation to rising and falling clock edges of the data transfer clock CLK-D.

From the time T1 to the time T11 in FIG. 2, a time period ΔT elapses. Within this time period ΔT, eleven data packets DP1, . . . , DP11 can be transferred in line with the invention. The time period ΔT is also shown in FIG. 1. In this case, it extends from the time TD1 to the time TD6 and is the same length as in FIG. 2, because the time T1 from FIG. 2 corresponds to the time TD 1 from FIG. 1, and the time T11 from FIG. 2 corresponds to the time TD6 from FIG. 1. As can be seen, only six data packets are transferred in the same period ΔT in the prior art, whereas the invention can be used to transfer eleven data packets within the time period ΔT. The data transfer rate can thus almost be doubled.

Although the present invention and its advantages have been described in detail, it should be understood that various changes, substitutions and alterations can be made herein without departing from the spirit and scope of the invention as defined by the appended claims.

1. A method for transferring data between a memory device and a read/write device, the method comprising:
providing a system clock at a system clock rate;
generating a data transfer clock at a data transfer clock rate, wherein the system clock rate is determined based upon a first criteria and wherein the data transfer clock rate is determined based on a second criteria that is different than the first criteria;
receiving a control command for controlling a data transfer cycle, the control command being received in sync with the system clock; and
transferring data in response to received control commands, the data being transferred in sync with the data transfer clock.

2. The method of claim 1 wherein receiving a control command comprises receiving a read command.

3. The method of claim 1 wherein receiving a control command comprises receiving a write command.

4. The method of claim 1 wherein the data transfer clock rate is higher than the system clock rate.

5. The method of claim 4 wherein the data transfer clock rate corresponds to an integer multiple of the system clock rate.

6. The method of claim 1 wherein the data transfer clock rate is optimized on the basis of parameters which stipulate the maximum data transfer rate which can be achieved between the memory device and/or the read/write device.

7. The method of claim 6 wherein the data transfer clock rate is optimized on the basis of a degree of parallelization.

8. The method of claim 6 wherein the data transfer clock rate is optimized on the basis of an access speed of the memory device.

9. The method of claim 6 wherein the data transfer clock rate is optimized on the basis of a characteristic of a read/write device that provides the commands.

10. The method of claim 1 wherein the system clock rate is optimized on the basis of an access time of the memory device.

11. The method of claim 1 wherein the system clock rate is optimized on the basis of a characteristic of a read/write device that provides the commands.

12. The method of claim 1 wherein the system clock rate is optimized on the basis of parameters that stipulate a maximum command transfer rate.

13. The method of claim 1 wherein the data transfer clock is produced from the system clock using a mode register set.

14. The method of claim 1 wherein the data transfer clock is produced from the system clock using an extended mode register set.

15. The method of claim 1 wherein the data transfer clock is generated using a radio clock.

16. The method of claim 1 wherein the data are transferred centered in relation to rising and/or falling clock edges of the data transfer clock using a delay locked loop circuit.

17. The method of claim 1 wherein data are transferred at a rate that is twice the frequency of the data transfer clock.

18. A method for transferring data between a memory device and a read/write device wherein:
a system clock is produced at a system clock rate;
a data transfer clock is produced at a data transfer clock rate, where the system clock rate and the data transfer clock rate can be set as desired;
control commands for controlling the data transfer are transferred in sync with the system clock; and
data are transferred in line with corresponding control commands in sync with the data transfer clock.

19. The method of claim 18 wherein the data transfer clock rate corresponds to an integer multiple of the system clock rate.

20. The method of claim 19 wherein information indicating the integer multiple is stored in a register.

21. The method of claim 20 wherein the register is located on the memory device.

22. The method of claim 18 wherein the data transfer clock rate is optimized on the basis of parameters that stipulate the maximum data transfer rate that can be achieved between the memory device the read/write device.

23. A method of operating a memory device that is formed on a single semiconductor substrate, the method comprising:
receiving a system clock at the memory device from a source external to the memory device, the system clock operating at a system clock rate;
generating a data transfer clock from the system clock, the data transfer clock operating at a data transfer clock rate;
receiving a control command from a source external to the memory device, the control command for controlling a data transfer cycle, the control command being received in sync with the system clock; and
transferring data in response to the received control command, the data being transferred at a rate that is higher than twice the system clock rate and in sync with the data transfer clock.

24. The method of claim 23 wherein the data transfer clock operates at a rate that is an integer multiple of the rate of the system clock.

25. The method of claim 24 and further comprising receiving an indication of the integer multiple from a source external to the memory device.

26. The method of claim 25 and further comprising storing the indication of the integer multiple in a register that is located on the semiconductor substrate of the memory device.
